(19) United States
(12) Patent Application Publication
(10) Pub. No.: US 2007/0005643 A1
(43) Pub. Date: Jan. 4, 2007

(54) Method and system for providing medical assistance to a traveler

(76) Inventor: Doron Korman, Kiryet-Byalik (IL)

Correspondence Address: SMITH FROHWEIN TEMPEL GREENLEE BLAHA, LLC, P.O. BOX 88148, ATLANTA, GA, 30356, US

(21) Appl. No.: 10/596,378

(22) PCT Filed:
(86) PCT No.: PCT/IL04/01071

Related U.S. Application Data
(60) Provisional application No. 60/529,127, filed on Dec. 12, 2003.

(51) Int. Cl. G06F 17/00

(52) U.S. Cl. 707/104.1

(57) ABSTRACT

A system for providing medical information and services to subscribers that are traveling abroad. The system include a server that houses a variety of databases for storing personal medical files for the subscribers, medical call centers in various countries, medicine and prescription information or the like. A subscriber traveling in a foreign country can access the server through the Internet using a client device. Upon accessing the server, the client can retrieve his or her medical information in a variety of languages, as well as identify locations to obtain medical help.

### CROSS-REFERENCE TO RELATED APPLICATIONS

This application claims the benefit of the filing date of United States Provisional Application for Patent entitled “METHOD AND SYSTEM FOR PROVIDING MEDICAL ASSISTANCE TO A TRAVELER” and which was filed on Dec. 12, 2003 and assigned Ser. No. 60/529,127, the content of which is incorporated herein by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to the field of database access and management and more particularly, to managing and provide access to medical services and information to subscribers using devices connected to a network.

When a person has traveled far away from home, medical care is not always handy or convenient. This difficulties associated with obtaining medical are especially enhanced when a language barrier exists. In such a situation, a traveler may face difficulties in finding the location of medical centers, expressing the medical problem, and/or communicating his medical history to local medical staff, etc. In addition, there is a risk that a traveler may be unconscious and unable to communicate with local medical personal.

An individual's medical measurements, including but not limited to, heart rate and blood pressure are important factors in determining the state of a person's health and the physical condition of a person's body in response to physical or emotional stress. Periodic monitoring of these physical parameters is particularly important for individuals suffering from cardiac disease and/or lowered cardiac functionality, or high blood pressure. However, physically healthy individuals may also wish to periodically monitor their heart rate and blood pressure in stressful situations. For example, when a person is traveling into an unknown environment, this may result in increasing the stress on the subject and thus, may affect his physiological conditions.

In addition, having the medical history of a subject readily available, may be a great support in determining the treatment to provide to the subject. The file history may point to trends in the medical condition of the subject, may point the subject's sensitivity to medicines, chronic disease, allergies, etc. The information on the medical history of a subject may include documents, images, charts, test results, etc. Documents such as those previously-listed may require large volumes of space and typically are written in the native language of the traveler. Therefore, handling and carrying documents with medical history of a subject while traveling is inconvenience and quite burdensome. Moreover, if a language problem exist, then the documents may be inefficient in communicating pertinent information to the medical care provider.

There are some techniques in the art that attempt to address the medical needs of a traveler. For example, a subject may get a “life saving card”. The life saving card may have limited medical information about the subject. The life saving card may include identification information, limited medical information, such as the type of blood, age, medicines being taken, etc.

Other services may offer an access to a medical personal file of a subject. The medical personal file may reside in a web site of the service provider. The medical personal file may have medical information regarding the subject and the amount of information may be significantly more extensive and detailed than the information available on the life saving card. However, existing medical web sites are more focused on supporting a user in his local environment—not while the user is traveling. For instance, the site may include information in the user's language and information that is limited to, or only pertinent to the user's country.

Therefore there is a need in the art for a service provider, system and method that may offer medical services to a traveler while the traveler is at a significant distance from his/her home. The service may offer a diverse solution that may support the traveler, who is in need of medical attention, by providing the assistance he requires.

The provided service may offer a personalized multilingual medical web site, which stores and manages the user's medical history in a user-friendly interface and provides medical information assistance and support for the user during international travel. For example, the multilingual medical web site can provide contact information to medical service providers in foreign countries.

Moreover, there is a need in the art for a service that provides a traveler with an option to communicate with a medical staff person located in his country or in any location of his choice and in one or more languages of the traveler's choice. The communication with the medical staff person in the traveler's country may be audio or video communication. In response to this communication, the medical staff person may provide the traveler with a prescription, in the appropriate language, or simply identify an over the counter medication that should be administered to the traveler. The prescription may simplify the interaction with a pharmacist in the foreign country in which the traveler is located.

In addition, there is a need for a service that may be used for drug brand name consultation. The medical staff person may deliver a description of the physical condition of the traveler (a referral) in the appropriate language in order to facilitate the communication of the traveler with a foreign medical staff person. The translated medical opinion may support the medical staff person in the foreign country to reach the appropriate diagnostic. In some cases, the medical translation may be done simultaneously while the traveler is in the foreign medical clinic or pharmacy.

Furthermore, there is a need in the field for a portable system for monitoring human subjects in a non-invasive manner that may deliver information regarding his physical condition. The system may be plugged in to a computer in the foreign country and may perform medical measuring. The computer can be the traveler's laptop or notebook computer or cellular phone or PDA or may be a computer in a hotel, a foreign clinic, etc.

### SUMMARY OF THE INVENTION

Exemplary embodiments of the present invention are directed toward a method and a system for providing medical assistance to a traveler while he is outside of his or her native country. Exemplary embodiments of the present invention provide one or more medical web sites (MWS). Each one of the MWS may comprise and manage a plurality of users' personal medical files (PMF). The information in each one of the PMFs may provide medical information, assistance and support for the user during international travel. The user may fill in his PMF with any important or relevant medical data. In some cases, the PMF may be updated by the service provider as a service to the subscribers. The subscriber will be able to access this information from any location in the world. When needed, the subscriber can access the PMF information and cause the accessed information to be translated into one or more particular languages that can be default languages or that can be selected from a list of available languages. For instance, prior to approaching a local medical center, the subscriber can access the desired information and translate the data into the preferred language of the local medical center. In an exemplary embodiment, the translation may be performed upon a request of the user to generate the medical information into one or more languages. The request for translating the medical files may be given prior to the subscriber embarking on the subscriber's international voyage. In another exemplary embodiment, the translation may be done into one or more popular languages, such as but not limited to English, Spanish, French, etc. In yet another embodiment, the data may be automatically translated based on the location from which the subscriber is accessing the data. In such an embodiment, the data may be provided in the subscriber's native language as well as the local language. The data may be provided as two separate sets of data, or the data can be provided as a single form with translated versions of the data coexisting. The PMF may have a plurality of links to other pages in the MWS or in other relevant servers, as it is described below.

The PMF most likely includes highly sensitive and private information of the traveling subscriber. Therefore, access to each one of the PMFs is limited to the subscriber himself. However, in some cases the traveling subscriber may be unconscious or unable to access the system by himself. In such a situation, a third party, such as a foreign medical staff person, may use an emergency password to access the data. The emergency password may enable a person to gain limited access to the medical information, such as allowing access to part of the personal information and blocking the access to the more sensitive information. The emergency password may be written over a life saving article (LSA). The LSA is further describe below in conjunction with the discussion of FIG. 3.

In addition to the PMFs, the MWS may comprise information regarding medical services and clinics in a plurality of locations all over the world and how to contact the medical service providers and clinics. The information may be organized according to location, type of medical services that can be provided there and the languages that the medical staff can speak. The user may select the appropriate medical service in a location, which is near to his current location, and may contact them according to the contact information that is stored in the MWS.

In addition, exemplary embodiments of the present invention may include one or more call centers. Each call center may offer the subscriber with remote medical assistance from a medical staff person. The medical staff in a call center that is selected by the traveler will be skilled in communicating in the traveler's preferred language. The communication delivered from the call center may be audio communication or audiovisual communication. The medical staff in the call center may respond to the communication with the traveling subscriber by offering a prescription in the local language for a medication or by identifying an appropriate over the counter medication. This advantageously simplifies the interaction of the traveler with a pharmacist in the foreign country. In addition, the medical staff in the call center may offer a medical description (also called a referral herein) of the medical problems of the traveler. The medical description may be done in a language that can be read by the local medical staff personal rendering medical services to the traveling subscriber. The medical description, as well as the prescription, may be sent by fax or by email or any other type of electronic messaging technique to the location of the traveler or to a number or email address designated by the traveler.

Furthermore, exemplary embodiments of the present invention may offer a life saving article (LSA). The LSA is a physical device that may be mechanical, electronic, electromechanical, or simply a form a media. For example, the LSA may be in the form of a credit card, a necklace with a notice plate, or key-holder with a medical plate, an electronic fob with an LCD display, etc. The LSA may comprise information regarding medical details, which are essential in case of emergency, a fast entrance code and the address (URL or Uniform Resource Locator) of the MWS to gain access to the traveler's PMF. The medical details may include information such as the blood type of the subscriber, the subscriber's allergies, emergency telephone numbers for the subscriber, the subscriber's home address, etc.

In addition, the traveler may subscribe to medical monitoring services. The medical monitoring services may provide a measuring device that can be worn or carried by the subscriber and that operates to measure at least one physiological parameter of the subscriber wearing or carrying the device. The measuring device may be a wrist-mounted device, for example by being attached with a wristband or other fastening article to the wrist of the traveler. Other exemplary embodiments of the present invention may use other portable or non-portable measuring devices that can communicate with a computer via a gateway or directly. Exemplary embodiments of the present invention preferably also operate to enable such measurements to be transformed into medical information about the user. The medical information extracted or received from the measuring device, may be sent through a portable wireless gateway via a connection to a computer. An exemplary connection may be based on the USB protocol (Universal Serial Bus). The computer initially receiving the medical information may or may not process the received information but ultimately transfers the data over the Internet to a medical monitoring server (MMS). The computer may be the traveler's laptop, or notebook or some other similar device including, but not limited to, a PDA or cellular phone. Additionally, the computer may be a PC (Personal Computer) in a hotel, a coffee house, etc. Exemplary embodiments of the present invention may automatically provide links in the medical personal files of the traveler that are located in the MWS. The links may point to the updated information in the MMS.

Moreover, the PMF of clients that are also clients of the MMS may have links to the medical information that is stored in the MMS. The information from the MMS may be retrieved by the medical staff in the call center. In another embodiment, the PMF in the MWS may be updated automatically by the MMS, when new measurements have been concluded. The MWS and the MMS and the call center may be co-located and may be connected over a computer network including, but not limited to, a LAN, WAN or INTERNET. Additional information about the operation of the device, the call center and the MMS, an exemplary portable wireless gateway, and an exemplary cellular gateway is disclosed in PCT applications numbers: PCT/IL01/01187 having the International Publication Number WO02/051307; PCT/IL02/00285 having the International Publication Number WO02/080762; PCT/IL02/00995 having the International Publication Number WO03/050643; PCT/IL02/00994 having the International Publication Number WO03/050642; PCT/IL02/00214 having the International Publication Number WO03/077745; and PCT/IL2004/000316 the contents of which are incorporated herein by reference.

Moreover, to satisfy a business-to-business (B2B) customer, the web pages may emulate the associated business. For example, this can be the case when the traveler is a customer of a life insurance company, and the life insurance company is the customer of the MWS. In this embodiment, the traveler can be issued an LSA with the name of the life insurance company, as well as other information about the company printed on the LSA. When the traveler accesses the MWS, the traveler is presented with a company oriented look and feel interface. For instance, the retrieved web pages can carry the name of the life insurance company rather than the medical web service company, and can include further customizations that are unique to the company.

It should be noted that the terms: “subscriber”, “subject”, “user”, “traveler” and “patient” are used interchangeably herein. And that the terms “Medical Service Center”, “Call Center” and “Medical Center” are also used interchangeably herein.

Other objects, features, and advantages of the present invention will become apparent upon reading the following detailed description of the embodiments with the accompanying drawings and appended claims.

### BRIEF DESCRIPTION OF THE DRAWINGS

The invention is herein described, by way of example only, with reference to the accompanying drawings, wherein:

FIG. 1 is a block diagram illustrating relevant elements in an exemplary embodiment of the present invention;

FIG. 2 is a block diagram illustrating relevant elements in an exemplary embodiment of a medical web server;

FIG. 3 illustrate an exemplary a Life Saving Card.

FIGS. 4a to 4c illustrate a block diagram with relevant sections in three exemplary web pages.

FIG. 5 is a flow diagram showing an exemplary method of using the services of a medical web server; and

FIG. 6 is a flow diagram showing an exemplary method for responding to pressing a function button.

### DESCRIPTION OF EXEMPLARY EMBODIMENTS

Referring now to the drawings, in which like numerals refer to like parts throughout the several views, exemplary embodiments of the present invention are described.

Exemplary embodiments of the present invention provide a method and system for providing medical assistance to a traveler. Exemplary embodiments of the present invention enable preliminary medical support to be rendered to the traveler in the traveler's preferred language. Moreover, exemplary embodiments of the present invention improve the interaction between a traveler in need of medical assistance, and the local medical staff. Exemplary embodiments of the present invention may offer a variety of services to a user.

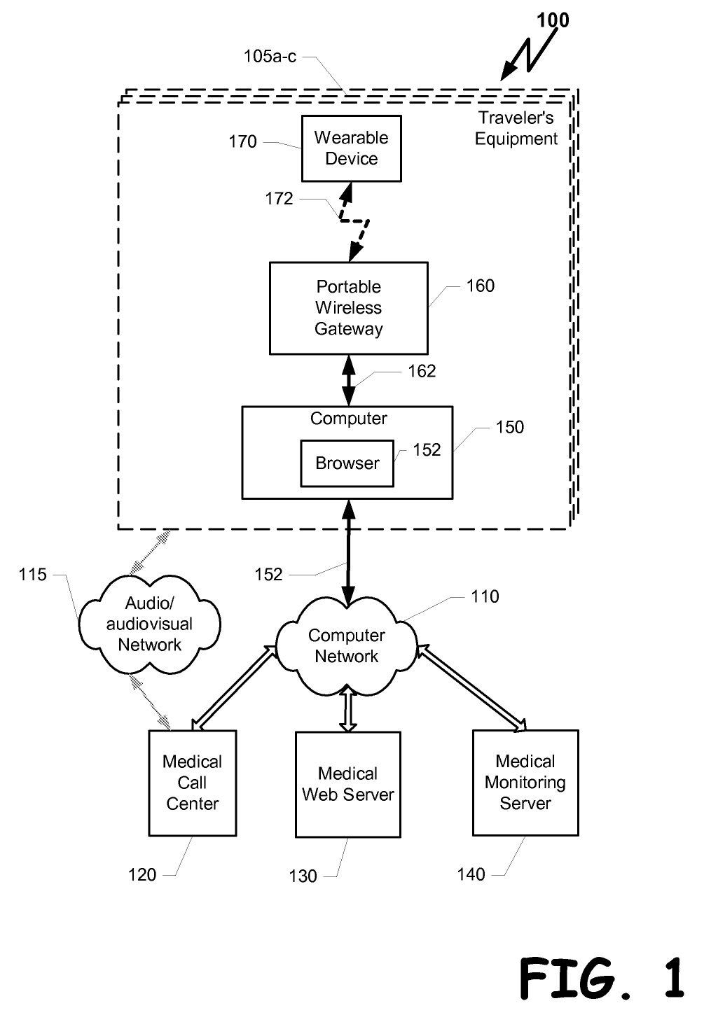

FIG. 1 illustrates a block diagram with relevant elements of an exemplary embodiment of a traveler support medical system 100 that uses an exemplary embodiment of the present invention. The system 100 may comprise a medical web server (MWS) 130, a plurality of traveler's equipment 105a-c, computer network 110, audio/visual network 115, a medical call center 120, and a medical monitoring server (MMS) 140. Although the illustrated embodiment of the present invention shows the use of three instances of traveler's equipment 105a-c, those skilled in the art will appreciate that this is simply and example and in fact, any number of traveler's equipment may actually be used in conjunction with the present invention. The computer network 110 may be the Internet and the audio/visual network 115 may be the PSTN (Public Switched Telephone Network), the ISDN (integrated services digital network) or the like. The communication over the audio/visual network 115 may also be based on the Internet Protocol (IP). In one exemplary embodiment of the invention, the traveler equipment 105a-c may comprise a computer 150, a portable wireless gateway 160 and a measuring device 170.

Call center 120, MWS 130 and the MMS 140 may be geographically dispersed or may be co-located. These elements may support travelers all over the world. In other embodiments, a plurality of call centers 120 may be utilized, and the MWSs 130 and MMSs 140 may be distributed all over the world. The call centers 120 in each country may support the travelers that are the citizens of that country while they are traveling abroad and/or may support travelers from other countries while they are traveling in the country in which the call center is located.

Medical staff that can communicate with the traveler may be located within the call center 120. The medical staff may have audiovisual equipment to facilitate the audio and or audiovisual communication with the traveler. The audio or audiovisual communication may be performed over the audio/visual network 115 or computer network 110 depending on the type of equipment that is used. For example, if a regular telephone is used, the communication may be performed over the audio/visual network 115. If the audio/visual communication is provided by using equipment that operates according to the IP (Internet Protocol), for example an IP phone or via the audio and/or audiovisual capabilities of the computer 150, the audio communication may be done over the IP network. In some cases, the visual communication may be implemented in only a single direction (i.e., from the call center to the traveler) while the traveler uses only audio equipment to communicate with the call center. In such a situation, images of the medical staff handling the call may be displayed over the display of computer 150.

The medical personal in the call center 120 may have a computer that may communicate with the MWS 130 and with the MMS 140. The communication may be performed over the Internet 110 or via a LAN or Intranet or any other computer network (not shown in the drawings). The medical personal may retrieve medical information, which is relevant to the traveler, from the MWS 130 and the MMS 140. Based on the retrieved information and potential communications with the traveler, the medical personnel at the call center can respond to the traveler needs.

The MMS 140 may receive medical information via the portable wireless gateway 160 and then operate to store this information in a database that resides within or is accessible to the MMS 140. The MMS 140 may also operate to process the stored data, and may create additional information that is relevant to the physical condition of the user. For example, the MMS 140 may look for and analyze any trends in the medical condition of the user and may identify any deteriorations or causes for alarm in user's the physical condition. In addition, the medical staff in the call center 120 may retrieve and analyze the stored data. It should be understood that the MMS 140 is not mandatory to the operation of the present invention and is simply one of the aspects that can be incorporated into the present invention. Thus, the subscriber can separately purchase or subscribe to the services available through the MMS 140 operating in conjunction with the portable GW 160 and the measuring device 170. Such a subscriber will then have access to the extended service that includes the monitoring, measuring and management of medical parameters while the subscriber. Additional information about the operation of the measuring device, the call center and the MMS is disclosed in PCT applications PCT/IL01/01187 having the International Publication Number WO02/051307; PCT/IL02/00285 having the International Publication Number WO02/080762; PCT/IL02/00995 having the International Publication Number WO03/050643; PCT/IL02/00994 having the International Publication Number WO03/050642, the contents of which are incorporated herein by reference and although certain aspects from these incorporated documents may comprise inventive elements in certain claims, the references are not considered as limitations for application or utilization of the present invention.

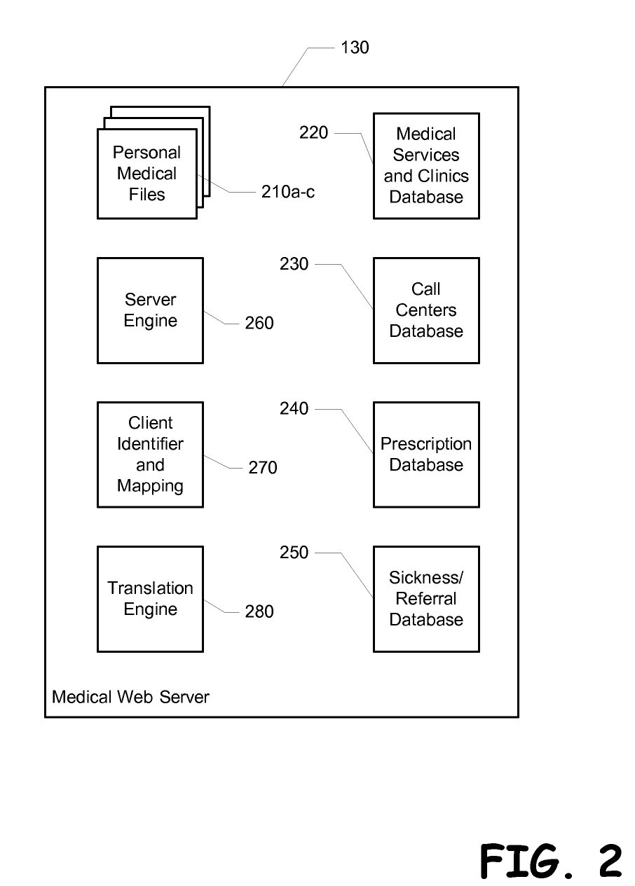

MWS 130 may comprise a plurality of personal medical files (PMF) for various users and databases with information on the medical services and clinics in a plurality of locations in various parts of the world. The information may be organized according to location, type of medical services that can be provided at the location and the applicable languages of the medical staff working in the facility. The user may interact with the MWS 130 via a computer network 110 and select the appropriate medical service in a location, which is in close proximity to his current location. Based on the contact information that is contained within the MWS 130, the traveler may select and contact a foreign medical service. The MWS 130 is disclosed in more detail below in conjunction with the discussion of FIG. 2.

At the traveler side 105a-c a computer 150 is needed. The computer 150 may be a variety of computing or data processing devices such as a laptop computer, a PDA, a cellular unit or a notebook computer. In other cases, the computer 150 may be any personal computer that can be accessed by the traveler, for example a PC in a hotel, Internet Café, or in a foreign clinic, etc. Preferably, the computer 150 runs a browser software program 152 and can be connected to the network 110. The browser is used in order to communicate with the MWS 130 over the network 110.

Using the computer and the browser, the traveler may retrieve his PMF from the MWS 130. The traveler may also update his PMF with new data. By using the links that are displayed on or integrated into the web pages retrieved from the MWS 130, the traveler may access or link to additional pages within the MWS 130 or MMS 140. These additional pages may include information regarding medical services and clinics in subscriber's current surroundings; information pertaining to the various call centers 120, etc. If the computer 150 includes audio and/or audiovisual capabilities, then the traveler may use those capabilities in order to communicate with a selected call center. If the computer does not have audio communication capabilities, then the traveler may use a common telephone, cellular phone, etc. to call the associated call center.

In some circumstances, a traveler may subscribe to other services in addition to the medical web services. One such additional service includes services for non-invasive monitoring of the traveler. Such a monitoring service can be very useful as part of the overall health maintenance of the human subject, and can be used in order to detect any type of deterioration in the physiological condition of the traveler before a concomitant deterioration in the health of the subject becomes noticeable. Examples of adverse physiological conditions that can be detected with non-invasive monitoring, include but are not limited to, arrhythmia and other heart conditions; loss of lung capacity or other problems with respiration, temperature fluctuations, body moisture fluctuations, etc. A traveler havin subscribed to this service, may receive a measuring device 170, access to a portable wireless gateway 160 and a link to an appropriate location for accessing the MMS 140. The link may be activated from the PMF. The measuring device 170 can be worn or carried by the traveler and when it is turned on or activated, it will operate to monitor one or more physiological parameters of the traveler. The information from the measuring device 170 can be transmitted 172 through the portable wireless gateway 160 via connection 162, such as but not limited to, a USB connection, to computer 150. In other embodiments of the present invention, communication line 162 between the Gateway 160 and the computer can be a wireless connection including but not limited to IR, Bluetooth, WiFi, etc. In some embodiments of the present invention, gateway 160 may be associated with the measuring device while in other embodiments the gateway may be associated with the computer. Computer 150 may or may not process the received information and regardless, it ultimately transfers the data over the computer network 110 to MMS 140.

Examples of medical information which may be extracted from the measured physiological parameter or parameters include, but are not limited to: heart rate; heart rate regularity; breathing rate; arrhythmia of the heart (if any), as well as the general rhythm and functioning of the heart; blood pressure (systolic and diastolic); presence of abnormal body movements such as convulsions for example; body position; fall detection; general body movements; body temperature; presence and level of sweat; oxygen saturation in the blood; and glucose levels in the blood, etc. It will be appreciated that considerable amounts of physiological information can be obtain through the use of non-invasive techniques using various sensors and measurement devices such as accelerometers, thermometers, resistance detectors, etc. It will also be appreciated that various assessments and diagnostic conclusions can be derived based on such physiological information and the present invention is not limited to any particular technique, although such various techniques disclosed herein may in and of themselves be novel.

In an exemplary embodiment, the portable wireless gateway 160 may include flash memory and the flash memory may contain software that operates the medical measuring system at the traveler's location. Such an embodiment may include two stages during its installation. At the first stage, the gateway may emulate a DiskOnKey (DiskOnKey is a registered trademark of M-Systems) application. After plugging the gateway into the USB plug, the user may use it as a DiskOnKey. The user can then load the operating software into the computer 150 or the operating software may automatically download into the computer 150 and automatically initialize itself. During the second stage, the medical measuring system is activated.

In other embodiments, the flash memory may include personal data, in addition to the operating software of the medical equipment. This personal data may include, but is not limited to, personal information, medical history, medical properties, statistical data of previous measurements, data regarding the physical condition of the user, special sensitivities of the user to medicines etc. Part or all of the personal data may be encrypted. In other exemplary embodiments of the portable wireless gateway 160, the software that operates the gateway 160 may reside in an associated CD ROM instead of the flash memory that is installed in the gateway 160. Additional information about the operation of an exemplary portable wireless gateway is disclosed in PCT application number PCT/IL2004/000316, the contents of which are incorporated herein by reference.

FIG. 2 is a block diagram illustrating an exemplary embodiment of a medical web server 130. The medical web server 130 may include a plurality of personal medical files (PMF) 210a-c, a medical services and clinics database 220, a call centers database 230, a prescription database 240, a sickness/referral database 250, a client identifier and mapping module 270, a translation engine 280, and/or a server engine 260 that controls the operation and the communication of the medical web server 130.

The server engine 260 may receive HTTP requests, or similar requests, to access web pages identified by URLs and then provide the web pages to the various client systems. An HTTP request may indicate a request for a web page that contains medical information obtained from one or more PMFs 210a-c or may also requests similar information from other web pages and from other databases. The request is generally checked by the client identifier and mapping module 270. The client identifier and mapping module 270 authenticates whether the requested information can be accessed by the requester. The authentication may be based on a user ID and password based access or by some other more robust and secure technique. Based on the result of the authentication, the request may be fulfilled or denied. In addition, the client identifier and mapping module 270 may comprise a map (table) of the MPFs 210a-c that are associated with each one of the subscribers. This mapping information can be used by the server engine 260 in order to generate the web page that matches the requested service and the current requester in order.

The medical services and clinics database 220 can include information regarding various medical services and clinics that are available and/or located in different locations around the world. The information provided for each clinic may include the location of the clinic, the languages spoken by staff working at the clinic, the website for the clinic, the hours of operation, the telephone number, the type of medical assistance provided, etc. Obtaining the appropriate information from the database may be done via one or more web pages or HTML based browser pages that allow a user to query or search the database on the different parameters or through links that point to the information stored in the database. The searching or link parameters can include, but are not limited to the location, the language spoken, the type of assistance, etc.

The call center database 230 comprises information on the various call centers available for a subscriber of the service to contact and communicate with medical staff in his language. The information on the call center may include the languages spoken, the website of the call center, the communication capabilities information such as providing the telephone number, indicating if they have audiovisual capabilities, etc.

The prescription database 240 provides or provides access to a plurality of prescriptions in various languages for pharmacy issued drugs as well as over the counter medication. In addition, prescription database 240 may have a database of drugs that are used all over the world. The drugs may be over the counter (OTC) drugs or drugs that need prescription (RX drugs). The prescription database 240 can also be used for drug consultation, such as identifying side effects of a drug, drug incompatibility and instructions regarding how the drug should be administered (i.e., on an empty stomach, without alcohol, etc.). The traveler that receives a prescription for an unknown drug from a local doctor can then identify a call center 120, contact a doctor associated with the call center and consult with the doctor regarding the type of the unknown medicine. The appropriate prescription may include instructions in the traveler's language as well as the local language. In addition, the prescription can provide the name of popular medications within the country in which the traveler is located. In order to eliminate mistakes, each prescription has a link to a version of the prescription that has been translated into the language of the traveler.

The Sickness (referral) database 250 comprises a plurality of descriptions of common illnesses and symptoms, such as but not limited to: abdominal pains, diarrhea, etc. The description can be provided in two or more languages and can help the traveler to interact and communicate with the foreign medical staff.

The translation engine (TE) 280 can be used to translate pre-filled-out forms from one language to another language. Both of the languages are selected from a group of languages in which the forms are written and stored in the TE 280. An exemplary form may include a question and a list of answers. For example, a question may be designed to identify the drugs to which the subscriber is sensitive or allergic. Then a list of drugs is provided below the question. Each drug can have an input box. A subscriber of the service is requested to select his preferred language. Then a web page in the preferred language including the questionnaire is sent to the subscriber and the subscriber is requested to mark the drugs to which he is sensitive. The response is stored as one of the MPFs 210a-c that is associated with this subscriber.

This information can then be requested and reviewed by foreign medical staff while the client is traveling. The information on the drug sensitivities is needed in other languages according to the request of the foreign medical staff. in operation, the TE 280 may retrieve the filled out form and transfer the data and selections to a form in the requested language, generate a web page with the new form and send it to the requesting party.

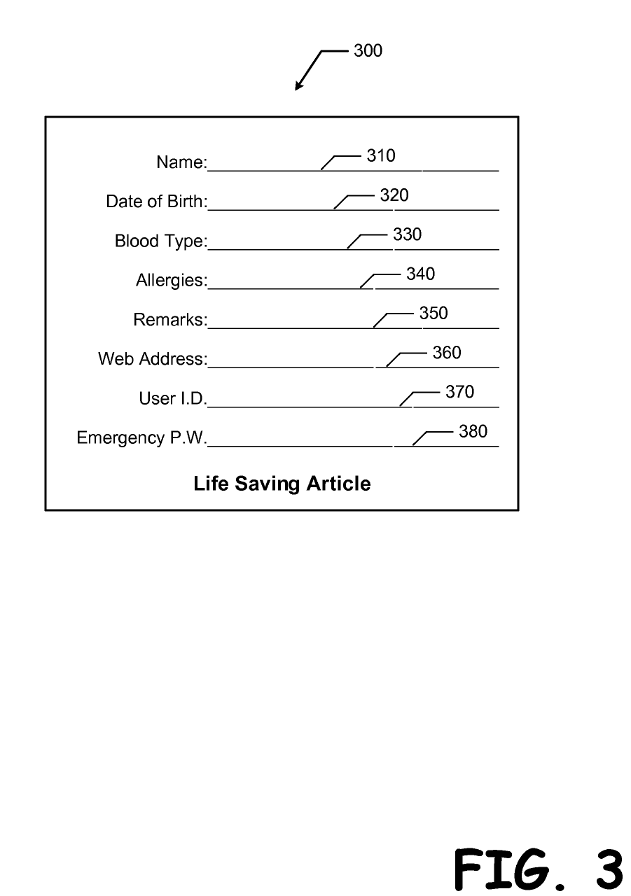

FIG. 3 illustrates an exemplary life saving article (LSA) 300. The LSA 300 may be in a variety of shapes or forms and the illustrated embodiment is in the shape of a credit card. Other exemplary embodiments of LSA 300 may include the shape of: a necklace with a notice plate, a key-holder with a medical plate and a sticker. Preferably, the LSA 300 displays information regarding the traveler carrying the LSA. The LSA information can include, but is not limited to, the traveler's name 310; the date of birth 320; the blood type 330; any allergies 340; and additional remarks 350 that may indicate other personal information regarding the traveler. In addition to the personal information, the LSA 300 may contain information about the MWS 130 (FIG. 1). The MWS information can include the URL of the MWS 360, identifying information such as the user ID that is associated with the traveler 370 and an emergency password 380 for accessing the MWS. The emergency password, as well as the user ID, can be used by emergency medical staff when the traveler is unconscious or otherwise unable to communicate. In some exemplary embodiments of the LSA 300, the user's ID 370 and the password 380 may be covered by a uniform color or material that can be easily removed by scratching it.

By using the web server address 360, ID number 370 and the emergency password 380, the emergency medical staff may communicate with the MWS 130 and retrieve information about the traveler. This information can assist them in providing medical support or attention to the traveler. The emergency access of the emergency medical staff may be limited to certain pages, records or data in the MWS 130. Typical pages that can be retrieved by the medical staff would include additional information on the traveler, such as but not limited to, his home address, telephone numbers, contact person etc. The allowed files may include medical information, such as but not limited to, results of previous medical reports, results of previous medical measurements, such as but not limited to, ECG, Spo2, glucose, etc. The information can be retrieved in a language that is selected by the medical personnel. The language may be a popular language such as English, Spanish, etc. The traveler may request, in advance to his travel, the translation of his medical files to one or more preferred languages.

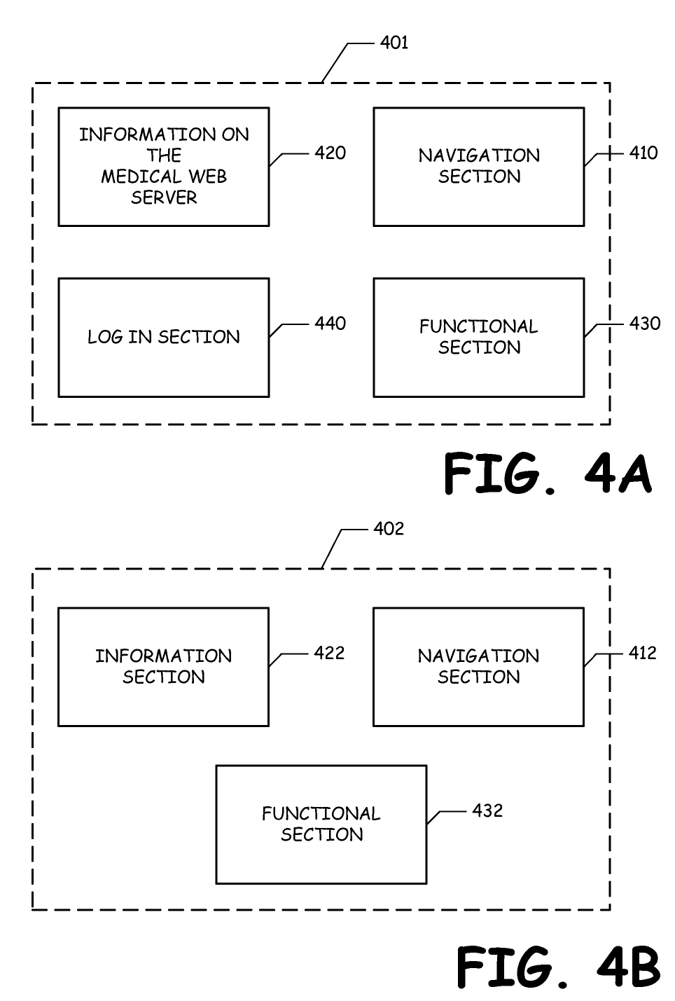

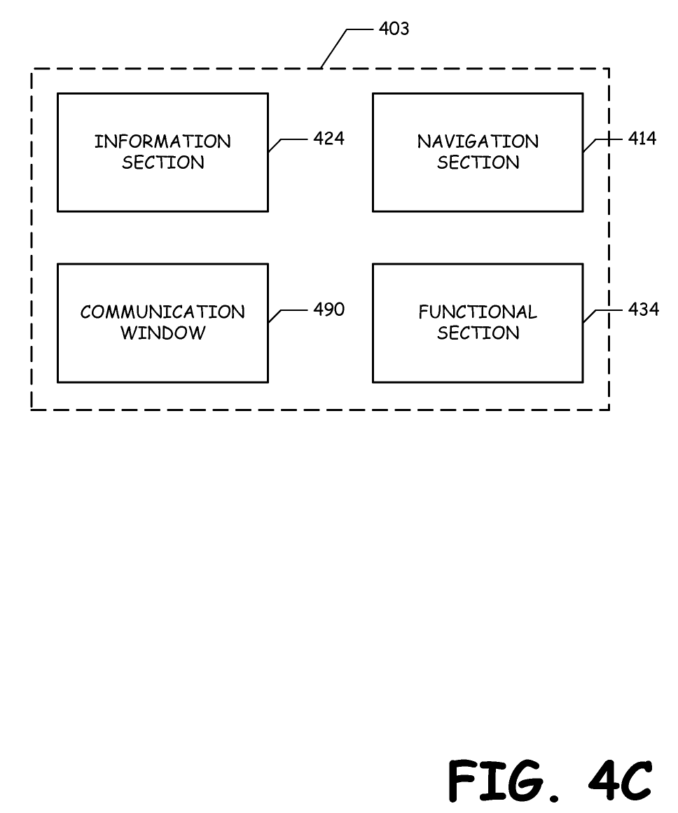

FIGS. 4a, 4b and 4c illustrate block diagrams with the relevant sections of three exemplary web pages. FIG. 4a illustrates an exemplary home page 401 of the MWS 130 (FIG. 1). Home page 401 can comprise a navigation section 410, an information section 420, a functional section 430 and a login section 440. The illustrated sections are logical sections and are not necessarily displayed in different sections of the screen or as illustrated. A certain area on the screen may comprise buttons and information from different logical sections.

The navigation section 410 can include navigation buttons that link to the different web pages that are accessible to the public. The navigation buttons may link to a page with information about the company (“About Us”); to a page with the type of services that may be delivered by the service provider (“Services”); to a page with the technology that is used by the service provider (“Technology”), etc.

The information section 420 can have a short description about the company and the web services in an effort to attract a reader to surf in the web site. The information may also include instructions regarding how to use the site to guide emergency medical staff that may not be familiar with the service. In a B2B situation, the information section may include information related to the associated business.

The functional section 430 can include buttons that initiate certain functions. Exemplary functional buttons can include “Proceed”, “Enter”, “Click for a free tour”, “Click for edit”, “Preferred language”, “Back”, “Forward” etc.

The login section 440 can comprise a User ID input box and a Password input box in which a user may type the relevant ID and password. The user may be the subscriber himself or a member of an emergency medical staff that is using the information that is written on the LSA 300 (FIG. 3). In addition to the input boxes, the area in the screen that is associated with the login may include functional buttons such as “Proceed”. Pressing the “Proceed” button may initiate the client identifier and mapping module 270 that is disclosed above in conjunction with the description of FIG. 2. The entered password may be used by the client identifier and mapping module 270 to determine whether the session is allowed and if the current session is initiated by the client himself or by emergency medical staff. Based on this decision, method 400 can proceed and deliver the appropriate information to the current user.

FIG. 4b illustrates an exemplary welcome page 402 that may be sent to a client of the MWS 130 (FIG. 1) after logging into the website. The welcome page 402 can comprise a navigation section 412, an information section 422 and functional section 432.

The navigation section 412 can comprise navigation buttons that link to the different web pages that are retrievable by the current client. The navigation buttons can link to the client's personal medical files (“My medical file”) or to pages with information that may be delivered to the client, such as a list of medical centers and clinics (“Local clinics”). Some of the navigation buttons may open a pull down list (sub menu) to allow additional selections by the client. For example, selecting the “Local clinics” button may open a sub menu for selecting the appropriate country. Selecting the country may open a sub menu to select the appropriate city. Selecting “My medical file” button may open a pull down list for selecting the type of medical files, such as but not limited to reports, images, test results etc. Selecting the images may open a sub menu with a list of images, such as, but not limited to ECG, X-Ray images etc.

The information section 422 can identify the information about the client that is available, such as but not limited to, the client's name, address, telephone numbers, emergency contact information or the like. In addition, the information section may include the retrieved or available information. For example, the information can be displayed and items, such as ECG graphs, may be displayed in the information section.

The functional section 432 can include buttons, such as but not limited to, a “preferred language button” to select a preferred language in which the reports may be retrieved and/or displayed. The function section 432 may also include a “Click for edit” button to allow the client to add or remove information from his personal files. Other buttons that can be included in the functional section are “Back”, “Forward” etc. Moreover, the functional key may include links to additional services to which the client is subscribed. Exemplary services may be: “MedicEye” or a service of “Remote Medical Measurements”, etc.

The “MedicEye” is a service that enables a visual connection session with a medical doctor that may be located in a call center 120 (FIG. 1) while audio communication may be done by a telephone, for example. If the traveler's equipment 105a-c (FIG. 1) supports an audiovisual connection, then the session may be a video communication session. More information on the “MedicEye” is disclosed below in conjunction with FIG. 4c and FIG. 6.

Selecting the “Remote Medical Measurements” button may instruct the client to plug in the portable wireless gateway 160 (FIG. 1) and to activate the measuring device 170 (FIG. 1). Then the computer 150 may perform several measuring cycles via the wireless gateway 160 and communicate the results to the MMS 130 (FIG. 1). The results may be transferred to MWS 140 (FIG. 1) as disclosed above in conjunction with the description of FIG. 1.

FIG. 4c illustrates an exemplary “MedicEye” page 403 that may be sent to a client of the MWS 130 (FIG. 1). The illustrated MedicEye page 403 is shown as including a navigation section 414, an information section 424, a functional section 434 and a communication window 490.

The navigation section 414 can comprise navigation buttons that link to the different web pages that can be retrieved by the client similar to the navigation section described in conjunction with FIG. 4b. The information section 424 can include information about the call centers to which the client may call, as well as other information, such as but not limited to, their telephone number, the variety of doctors that may be selected by the client, etc.

The functional section 434, in addition to other functions, may include buttons to select a preferred requested service, select a preferred language, request a prescription for a drug, or request a referral to assist a local doctor. Moreover, the functional key may include links to additional services, such as establishing a video connection with a video camera that is located in the call center 120 (FIG. 1) and is connected to network 110 (FIG. 1). The video from the camera may be added to the HTML page that is sent to the client and may be displayed on the monitor of the client computer in the communication window 490.

It should be understood that the different sections illustrated in FIGS. 4a-4c have been provided by way of example only and are not intended to limit the scope of the invention. Some embodiments of the present invention may comprise different combinations of sections and screens. Moreover, the association to a certain section is defined by the functionality of the button and not by its location in the screen.

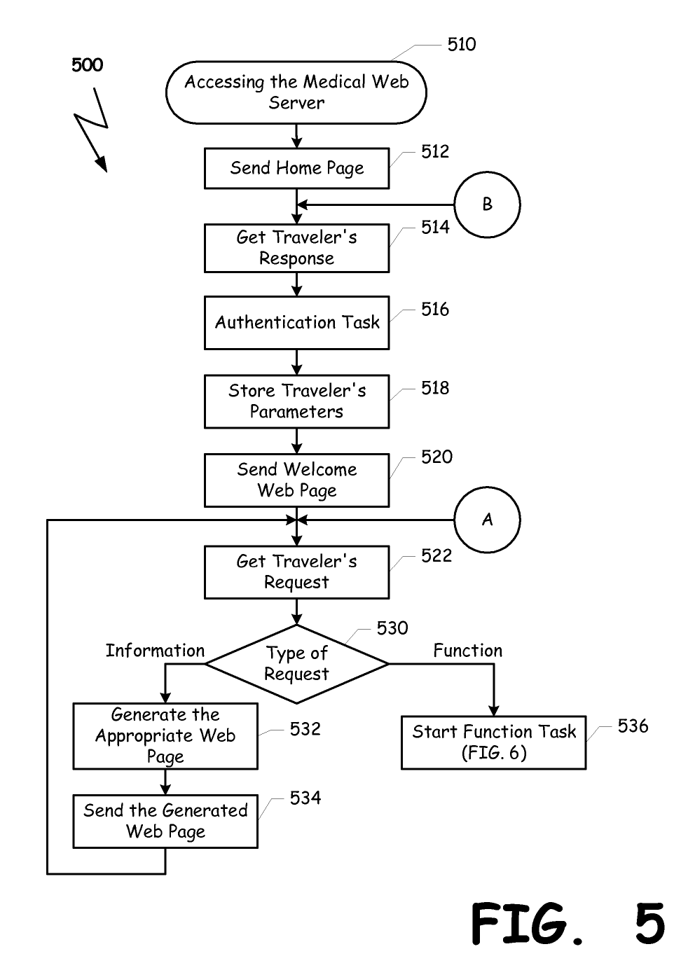

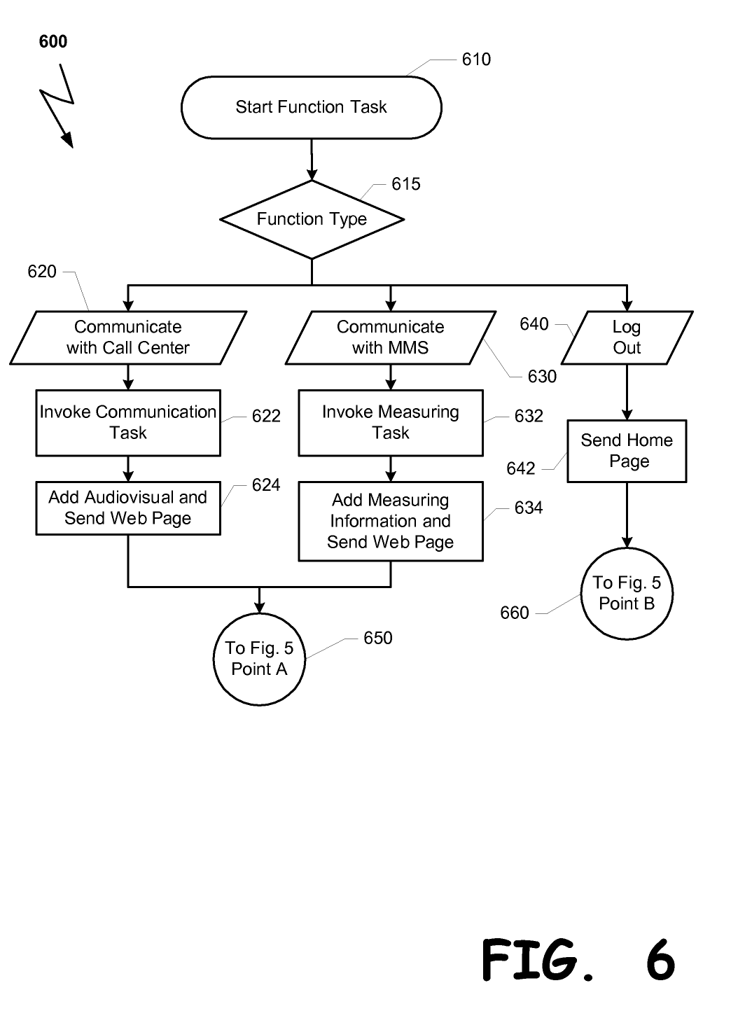

FIG. 5 illustrates a flowchart with the relevant steps of an exemplary method 500 performing various aspects of an embodiment of the present invention. The method 500 may be used during a communication session between a traveler and/or emergency medical staff and the medical web server 130 (FIG. 1). The description of FIGS. 5 and 6 refers to the traveler or the emergency medical staff as the requester. The method 500 may be initiated at point 510 when the requester establishes a connection with the medical web server 130. Once the connection is established, then an HTTP request is sent to the IP address of the medical web server. In response to the HTTP request, the MWS 130 sends an HTML file illustrating the “home page” of the medical web server 512. An exemplary home page is disclosed above in conjunction with the description of FIG. 4a.

In response to receiving the home page, the requester may login to the MWS 130. At step 514, the medical web server receives the requester login information and initiates an authentication task 516.

The authentication task 516 may be preformed by the client identifier and mapping module 270 (FIG. 2). The authentication task 516 operates to authenticate the access of the requester. The authentication may be based on the user ID and the password and/or other credentials or parameters. If the authentication fails or the provided credentials are not valid, the access to the MWS 130 is denied and the method 500 is terminated. If the password and the user ID number, or other credentials, are valid (i.e., match a legal requester), then a decision is made whether the requester is a traveler or an emergency medical staff person. Based on this decision, the client identifier and mapping module 270 operates to store the parameters of the relevant MPF 210a-c (FIG. 2) and the services that are associated with the requester into a cross-index table (map) 518. In an embodiment that is used for business-to-business (B2B) applications, the associated business may be written in the cross-index table. The cross-index table is used for retrieving the relevant information that is associated with the requester. For example, the cross-index table may point to the location of the medical files of the traveler. The information in the cross-index table may be used when the requester pushes the navigation button pointing on “my medical files”. Then method 500 may use the cross-index table to select the appropriate MPFs to generate the web pages that will be transferred to the requester.

In the situation where the requester is a B2B traveler, the cross-index table may define the location of the web pages having the title of the associated business. For example, if the associated business is a life insurance company, then the cross-index table may point to the web pages with the title of the life insurance company.

After storing the parameters, a welcome web page 402 (FIG. 4b) is sent to the client 520. The welcome web page 402 may greet the requester and offer the services and the information that are associated with the requester. More information on the welcome page 402 is disclosed above in conjunction with the description of FIG. 4b. Next, the web server waits for the reception of the next request from the requester 522.

Upon reception of the next request 522, the type of request is examined in decision block 530 to determine whether the request is for additional information or for invoking a function. If the request is for invoking a function, then the function task is initiated 536. Exemplary functions that can be included in the system can include initiating communication with a call center, starting a medical measuring task, logging out, etc. An exemplary method for handling a function task is disclosed below in conjunction with the description of FIG. 6.

If the request is for additional information, the appropriate web page to convey the information is generated 532. To generate the web page, the appropriate MPFs 210a-c (FIG. 2) are selected. The selection of the MPF 210a-c may be based, at least in part, on the cross-index table. The web page is then generated based on the selected MPFs 210a-c. The generated web page is sent to the client computer 534 and the method 500 returns to step 522 to wait for the next request.

FIG. 6 is a flowchart diagram illustrating the relevant steps of an exemplary method 600 for performing a requested function. The method 600 is initiated at step 610 when the request is identified as a request for a certain function to be performed (step 536 in FIG. 5) by the MWS 130 (FIG. 1). The function type is analyzed at step 615 and a decision is made as to whether the function is a request (a) to establish communication with the call center 620, (b) to establish communication with the MMS 630 or (c) to logout 640 from the services of the MWS 130. Although only three exemplary functions are shown in the illustrated example, it will be appreciated that other functions may also be handled by the present invention.

If it is determined that the request is to establish communication with a call center 620, a communication task 622 is initiated. The MWS 130 operates to retrieve the appropriate communication web page (an exemplary communication page is disclosed above in conjunction with the description of FIG. 4c). In parallel with this operation, the MWS 130 can initiate a Java applet that may communicate with a network camera that is located at the call center in the room of a selected medical doctor. In an exemplary embodiment, the network camera is an IP device with an IP address. The URL of the network camera may be added as an input to an HTML page. An exemplary network camera may be manufactured by AXIS (Axis Communications AB Emdalavagen 14 SE-223 69 Lund Sweden.) Then the communication page with the video coming from the network camera is sent to the client 624 and the method 600 continues at step 650 and returns to point ‘A’ in FIG. 5 (step 522) waiting for the next request.

In parallel the requester may establish an audio session with the medical doctor at the call center. The audio session may be set up via a variety of techniques, one such technique being a common telephone. The communication page 403 (FIG. 4c) that is sent to the client may indicate that the requester can contact a doctor in the call center by using a telephone. When the connection is established, the requester may view the doctor in the communication window 490 (FIG. 4c), talk with him through the telephone and send additional requests to the MWS 130 (FIG. 1) via the medical page. An exemplary request may be a request for a prescription in a certain language.

In another exemplary embodiment, in which the traveler may have video communication capabilities, a videoconference session may be established between the traveler and the medical staff in the call center. Furthermore, an additional party, such as a second doctor, a pharmacist, or a medical staff person from another call center can join the conference for consultation or further support. The additional party may be co-located with one of the other parties or may be located remotely from the call center and/or the traveler.

If the requested function is to initiate a medical measuring cycle 630, a measuring task is initiated 632. The MWS 130 may instruct the measuring device 170 (FIG. 1) via computer 150 (FIG. 1) and the portable wireless gateway 160 (FIG. 1) to start a medical measuring cycle. In some embodiments of the present invention, the MWS 130 (FIG. 1) may send, via the computer 150 (FIG. 1), an instruction to the requester to push a start button in the measuring device 170 (FIG. 1) in order to start a measuring cycle. The result of the measuring cycle may be sent to the MWS 130 (FIG. 1) and to MMS 140 (FIG. 1). The MWS 130 may add the results of the measuring cycle to the web page and send the web page to the requester 634. The MWS 130 and/or the MMS 140 may process the information before sending the results to the requester. If a medical doctor is involved, the doctor may receive and observe the results of the recent medical measurements. Then method 600 then continues at step 650 where processing returns to point ‘A’ in FIG. 5 (step 522) waiting for the next request. More information on the operation of the measuring device 170 (FIG. 1), the computer 150 (FIG. 1) and the portable wireless gateway 160 (FIG. 1) is disclosed in the PCT application number PCT/IL2004/000316 the content of which is incorporated herein by reference.

If the requested function is a logout 640, the MWS 130 may send the home page to the requester and continue processing at point ‘B’ (step 514 in FIG. 5) waiting for the response of the requester.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for delivering medical assistance to a traveler while visiting in a foreign country, the traveler utilizing a client system, the method comprising the steps of:
displaying one or more selection buttons on a display of the client system, each selection button being associated with at least one type of medical assistance, the medical assistance being provisioned in at least two different languages and being associated with at least two countries;
receiving a selection of one of the selection buttons;
sending a request to a server; and
the server delivering the medical assistance associated with the selected button in the selected language and customized based on the selected country.

2. The method of claim 1, wherein the step of delivering the medical assistance comprises selecting medical assistance from a group consisting of: providing information on medical services in the foreign country, translating a prescription to the foreign language, translating medical information of the traveler into the foreign language, delivering a medical referral in the foreign language, providing online medical consulting in a preferred language of the traveler, and providing online drug consultation in a preferred language of the traveler.

3. The method of claim 1, wherein the at least one type of medical assistance includes providing an over the counter (OTC) prescription depending on the foreign country requirements.

4. The method of claim 1, wherein the client system and server system communicate via the Internet and the step of sending the request to the server comprises sending the request over the Internet.

5. The method of claim 1, further comprising a life saving article, the life saving article identifying emergency medical information that is related to the traveler and a URL for the server, and the step of sending a request to a server further comprises sending the request to the URL identified on the life saving article.

6. The method of claim 5, wherein the life saving article is selected from a group consisting of a necklace with a notice plate, a plastic card, or key-holder with a medical plate and a sticker.

7. The method of claim 5, wherein the life saving article comprises an emergency password and the step of sending a request to the server further comprises sending the emergency password.

8. The method of claim 1, further comprising a medical measurement device that can be attached to the traveler and is operable to take certain medical measurements of the traveler, and the method further comprises the step of taking the certain medical measurements and transferring the certain medical measurements to the server.

9. A server for delivering medical assistance to a traveler, the server being accessible by a traveler while traveling in a foreign country and operating a client device, the server comprising:
a medical personal file database comprising a plurality of medical personal files, wherein each medical personal file includes medical information pertaining to the traveler in two or more languages;
a medical services database containing entries to identify medical services offered at a particular location in a particular country; and
a network interface enabling a traveler to access the medical personal file database and the medical service database.

10. The server of claim 9, further comprising an authenticated login interface that requires the entry of identifying information to gain access to the medical personal file for a traveler and includes an emergency access code that allows limited access to the medical information pertaining to the traveler.

11. The server of claim 9, wherein the medical personal file database further comprises information regarding the language compatibility of the staff at the medical services.

12. The server of claim 10, wherein the medical information pertaining to the traveler in the medical personal file database includes an identification of the medications that the traveler is currently taking, the medical history of the traveler and the current medical condition of the traveler.

13. The server of claim 9, wherein the server is operable to receive medical measurements information from the client device and store the medical measurements in the medical personal file database.

14. The server of claim 9, wherein the medical personal files are updated manually.

15. A system for providing medical assistance and services to a traveler using a client device communicatively connected to a communications network, the system comprising:
a medical web server, communicatively connectable to the communications network, the medical web server comprising:
a database of a plurality of medical personal files, wherein each medical personal file includes medical information associated with the traveler in two or more languages,
a database of medical services in two or more countries; and
a database of prescriptions and referrals in two or more languages;
a client device communicatively connected to the communications network and comprising a client computer running a browser; and
the communications network operable for connecting the medical web server with the client computer of the client device and thereby giving the traveler access to the database of a plurality of medical personal files, the database of the medical services and the database of prescriptions and referrals while the traveler is in a foreign country; and
the medical web server being operable to receive a request for information from the client device, the request identifying a desired information, a desired language and a current country, and provide the desired information in the requested language and in accordance with the current country.

16. The system of claim 15, wherein the database of prescriptions comprises brand names of medicines in the foreign country.

17. The system of claim 15, further comprising a database of call centers in one or more locations.

18. The system of claim 15, wherein the client device further comprises:
a gateway that is connected to the client computer; and
a measuring device operable to measure certain information pertaining to the traveler and transfer the certain measurements to the client computer via the portable gateway.

19. The system of claim 18, wherein the certain measurements are transferred from the client computer to the web server.

20. The system of claim 18, wherein the gateway is portable.

21. The system of claim 18, wherein the measuring device is portable.

22. The system of claim 15, wherein the service of the system is associated with a company and wherein the traveler is a customer of the associated company.

23. The system of claim 15, wherein the medical web server further comprises an authenticated user interface wherein access to the database of a plurality of medical personal files, the database of the medical services, the database of call centers and the database of prescriptions and referrals is only granted if valid credentials are entered.

24. The system of claim 23, wherein an emergency set of credentials, if entered at the authenticated user interface, grants limited access to the database of a plurality of medical personal files.

25. The system of claim 15, wherein the client device is operable to engage in an audiovisual communication session with a medical service identified in the database of medical services.
